(19) United States
(12) Patent Application Publication
(10) Pub. No.: US 2010/0225606 A1
(43) Pub. Date: Sep. 9, 2010

(54) TOUCH PANEL

(75) Inventors: Kazuhiro SASAKI, Sagamihara-shi (JP); Makoto Iwasaki, Akishima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/716,685

(22) Filed: Mar. 3, 2010

(30) Foreign Application Priority Data
Mar. 4, 2009 (JP) 2009-051027

(51) Int. Cl. G06F 3/041

(52) U.S. Cl. 345/173

(57) ABSTRACT

A touch panel includes a first substrate, a second substrate disposed to face the first substrate, a resistive film formed on the second substrate, spacer receivers formed of an insulating material on the resistive film, projecting spacers formed on the first substrate, and projecting contacts formed on the first substrate. The spacer receivers have a predetermined area and a predetermined thickness. The projecting spacers protrude at a predetermined height. The projecting contacts protrude equally in height to the projecting spacers. The tips of the projecting spacers are in contact with the spacer receivers. The tips of the projecting contacts are out of contact with the spacer receivers.

### CROSS-REFERENCE TO RELATED APPLICATIONS

This application is based upon and claims the benefit of priority from prior Japanese Patent Application No. 2009-051027, filed Mar. 4, 2009, the entire contents of which are incorporated herein by reference.

### BACKGROUND OF THE INVENTION

1. Field of the Invention

This invention relates to a resistive film type touch panel.

2. Description of the Related Art

In a resistive film type touch panel, a first substrate on which a first resistive film is formed and a second substrate on which a second resistive film is formed are arranged so that the first resistive film and the second resistive film face each other. This resistive film type touch panel is configured so that one of the substrates touched by a user is bent and deformed by pressing at the touched position and then the first resistive film and the second resistive film come into contact with each other in a region corresponding to the touched position. Then, the position where the first resistive film and the second resistive film are in contact with each other is detected as a position touched by the user.

In such a resistive film type touch panel, a plurality of spacers are provided between the first substrate and the second substrate to provide a gap between the first substrate and the second substrate so that the first resistive film and the second resistive film may not come into contact with each other when there is no input touch (Jpn. Pat. Appln. KOKAI Publication No. 61-45519).

However, when a great gap is set between the first substrate and the second substrate to prevent unnecessary contact between the first substrate and the second substrate, the substrate has to be touched so that the substrate may be bent and deformed to a great extent in order to bring the first resistive film and the second resistive film into contact with each other.

Therefore, in a touch-panel-equipped display apparatus in which the above-described conventional resistive film type touch panel is disposed on an image display surface of a display panel such as a liquid crystal display panel, light exiting from the display panel is greatly refracted in the part where the resistive film type touch panel is bent and deformed, and an image in this part appears to be distorted.

### BRIEF SUMMARY OF THE INVENTION

An object of the present invention is to provide a resistive film type touch panel in which, when it is touched by a user, the change of the path of light transmitted through the part bent and deformed by touching can be reduced, and variation of the sense of touch among products can be reduced.

A touch panel according to an aspect of the present invention includes a first substrate; a second substrate disposed to face the first substrate; a resistive film formed on the second substrate; spacer receivers formed of an insulating material on the resistive film, the spacer receivers having a predetermined area and a predetermined thickness; projecting spacers formed on the first substrate, the projecting spacers protruding at a predetermined height, the tips of the projecting spacers being in contact with the spacer receivers; and projecting contacts formed on the first substrate, the projecting contacts protruding equally in height to the projecting spacers, the tips of the projecting contacts being out of contact with the spacer receivers.

A touch panel according to another aspect of the present invention includes a first substrate; a second substrate disposed to face the first substrate; projecting spacers formed on the first substrate, the projecting spacers protruding at a predetermined height; projecting contacts formed on the first substrate, the projecting contacts protruding equally in height to the projecting spacers and being off the location of the projecting spacers; a resistive film formed on the second substrate; and spacer receivers formed of an insulating material with a predetermined thickness on the resistive film, the spacer receivers being only in contact with the projecting spacers between the projecting spacers and the projecting contacts.

A touch panel according to still another aspect of the present invention includes a first substrate; a second substrate disposed to face the first substrate; projecting spacers formed on the first substrate, the projecting spacers protruding at a predetermined height; projecting contacts formed on the first substrate, the projecting contacts protruding equally in height to the projecting spacers and being off the location of the projecting spacers; a resistive film formed on the second substrate; and insulating layers formed on the resistive film so that regions corresponding to the projecting contacts are exposed from the insulating layers and the tips of the projecting spacers are in contact with the insulating layers.

According to the present invention, when a touch panel is touched by a user, the change of the path of light transmitted through the part bent and deformed by touching can be reduced, and variation of the sense of touch among products can be reduced.

Advantages of the invention will be set forth in the description which follows, and in part will be obvious from the description, or may be learned by practice of the invention. The Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view of a touch-panel-equipped display apparatus;

FIG. 2 is a plan view of a touch panel in a first embodiment;

FIG. 3 is a plan view of the configuration of the touch panel in the first embodiment on the side of a touch-side substrate;

FIG. 4 is a plan view of the configuration of the touch panel in the first embodiment on the side of an opposite substrate;

FIG. 5 is a sectional view of the touch panel in the first embodiment;

FIG. 6 is an enlarged sectional view of part of the touch panel in the first embodiment;

FIG. 7 is an enlarged sectional view of part of the touch panel in the first embodiment during touch-input;

FIG. 8 is an enlarged view of part of FIG. 6;

FIG. 9 is an enlarged sectional view of part of a touch panel in a comparative example;

FIG. 10 is an enlarged view of part of FIG. 9;

FIG. 11 is a diagram showing a touch panel drive circuit; and

FIG. 12 is an enlarged sectional view of part of a touch panel in a second embodiment.

### DETAILED DESCRIPTION OF THE INVENTION

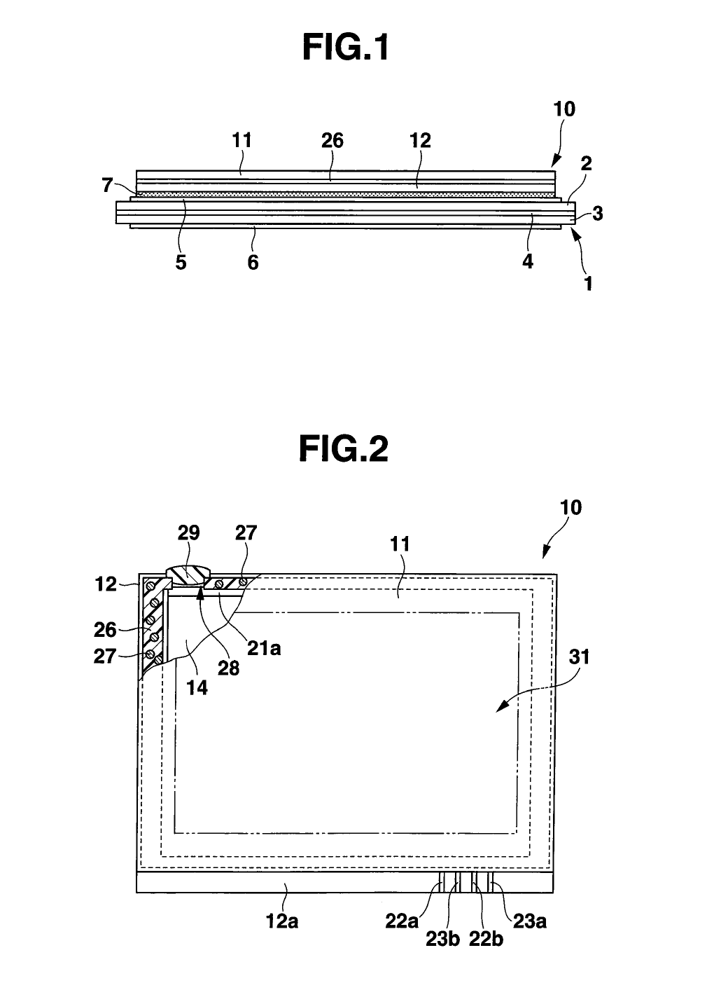

A touch-panel-equipped display apparatus is shown in FIG. 1. This display apparatus comprises a display panel 1 for displaying images, and a resistive film type touch panel 10 disposed on the image display surface of the display panel 1.

The display panel 1 is, for example, a liquid crystal display panel which controls, per display pixel, the transmission amount of light radiated from a backlight to display images. In the liquid crystal display panel, a first transparent substrate 2 and a second transparent substrate 3 are arranged to face each other with a predetermined gap. The first transparent substrate 2 and the second transparent substrate 3 are joined together through a frame-like seal member 4 at the peripheral edge. Further, liquid crystal is confined in a region enclosed by the seal member 4 so that a liquid crystal layer is formed in the gap between the first transparent substrate 2 and the second transparent substrate 3. A space defined by the seal member 4 and the first and second transparent substrates 2 and 3 is filled with the liquid crystal. In addition, a transparent electrode for applying a voltage to the liquid crystal per display pixel is formed in the first transparent substrate 2 or the second transparent substrate 3. Moreover, the liquid crystal display panel includes a first polarizing plate 5 and a second polarizing plate 6 which are arranged to hold the first transparent substrate 2 and the second transparent substrate 3 in between.

It is to be noted that the liquid crystal layer in the liquid crystal display panel may have nematic liquid crystal in TN alignment, STN alignment, nontwist homogeneous alignment, vertical alignment or bend alignment, or may have ferroelectric or antiferroelectric liquid crystal.

Furthermore, the transmission amount of light in the liquid crystal display panel may be controlled in the following manner: Electrodes are formed to generate a vertical electric field in the liquid crystal layer, and the alignment direction of liquid crystal molecules is changed by the vertical electric field to control the transmission amount of light. Alternatively, electrodes are formed to generate a horizontal electric field in the liquid crystal layer, and the alignment direction of the liquid crystal molecules is changed by the horizontal electric field to control the transmission amount of light.

Moreover, the display panel 1 is not exclusively a liquid crystal display panel, and may be a light-emitting-type display panel such as an organic electroluminescent (EL) display panel.

The touch panel 10 is disposed to face the liquid crystal display panel 1. In this case, the touch panel 10 is affixed to the first polarizing plate 5 of the liquid crystal display panel 1 by an adhesive layer 7 made of a transparent pressure sensitive adhesive material or resin.

### Embodiment 1

As shown in FIG. 2 to FIG. 8, a touch panel 10 in a first embodiment of this invention comprises a pair of first and second transparent substrates 11, 12, a first resistive film 13, a second resistive film 14, a plurality of projecting contacts 15, a plurality of projecting spacers 16, and a plurality of spacer receiving insulating layers 19. The first and second transparent substrates 11, 12 are arranged to face each other. The first resistive film 13 is formed on the inner surface, which faces the second substrate (hereinafter referred to as an opposite substrate) 12, of the first substrate, for example, touch-side substrate 11 of the two substrates 11, 12. The second resistive film 14 is formed on the inner surface of the opposite substrate 12 facing the touch-side substrate 11. The projecting contacts 15 are provided at a plurality of positions of the first resistive film 13 so as to protrude at a predetermined height from the surface of the first resistive film 13. The projecting contacts 15 contact the other resistive film, that is, the second resistive film 14 provided on the inner surface of the opposite substrate 12 due to the bending and deformation of the touch-side substrate 11 caused by touching from its outer side. The projecting contacts 15 bring the first resistive film 13 and the second resistive film 14 into conduction at a touched portion. The projecting spacers 16 are made of the same material as the projecting contacts 15, and provided at a plurality of positions of the first resistive film 13 different from the positions of the projecting contacts 15 so as to protrude at the same height as the projecting contacts 15. The spacer receiving insulating layers 19 are formed with a predetermined thickness on the second resistive film 14 so as to correspond to the projecting spacers 16, respectively. The spacer receiving insulating layers 19 are in contact with the tips of the projecting spacers 16. The spacer receiving insulating layers 19 set, together with the projecting spacers 16, the gap between the pair of substrates 11, 12 (the gap between the first and second resistive films 13, 14) at a value higher than the height of the projecting contacts 15.

That is, a touch panel 10 comprises at least the following: a first transparent substrate 11 as a touch-side substrate; a second transparent substrate 12 disposed as an opposite substrate to face the first transparent substrate 11; a second resistive film 14 formed on the second transparent substrate 12; spacer receiving insulating layers 19 as spacer receivers formed of an insulating material on the second resistive film 14 so as to have a predetermined area and so as to have a predetermined thickness; projecting spacers 16 formed on the first transparent substrate 11 so as to protrude at a predetermined height, the tips of the projecting spacers being in contact with the spacer receiving insulating layers 19; and projecting contacts 15 formed on the first transparent substrate 11 so as to protrude equally in height to the projecting spacers 16, the tips of the projecting contacts being out of contact with the spacer receiving insulating layers 19.

Furthermore, in other words, a touch panel 10 comprises at least the following: a first transparent substrate 11 as a touch-side substrate; a second transparent substrate 12 disposed as an opposite substrate to face the first transparent substrate 11; projecting spacers 16 formed on the first transparent substrate 11 so as to protrude at a predetermined height; projecting contacts 15 formed on the first transparent substrate 11 so as to protrude equally in height to the projecting spacers 16 and so as to be off the location of the projecting spacers 16; a second resistive film 14 formed on the second transparent substrate 12; and spacer receiving insulating layers 19 as spacer receivers formed of an insulating material with a predetermined thickness on the second resistive film 14 to be only in contact with the projecting spacers 16 between the projecting spacers 16 and the projecting contacts 15.

Still further, in other words, a touch panel 10 comprises at least the following: a first transparent substrate 11 as a touch-side substrate; a second transparent substrate 12 disposed as an opposite substrate to face the first transparent substrate 11; projecting spacers 16 formed on the first transparent substrate 11 so as to protrude at a predetermined height; projecting contacts 15 formed on the first transparent substrate 11 so as to protrude equally in height to the projecting spacers 16 and so as to be off the location of the projecting spacers 16; a second resistive film 14 formed on the second transparent substrate 12; and spacer receiving insulating layers 19 as insulating layers formed on the second resistive film 14 so that regions corresponding to the projecting contacts 15 are exposed from the insulating layers and the tips of the projecting spacers 16 are in contact with the spacer receiving insulating layers.

The touch-side substrate 11 of the pair of substrates 11, 12 is made of a rectangular glass plate or resin film having a thickness of 0.2 to 0.3 mm. The opposite substrate 12 is made of a glass plate having a thickness of 0.5 to 1.0 mm. The opposite substrate 12 is formed into a rectangular shape substantially equal in size to the touch-side substrate 11. An extension 12a extending outward from the touch-side substrate 11 is integrally formed on one edge of the opposite substrate 12.

In addition, when a soda glass plate or the like is used for the pair of substrates 11, 12, it is desirable to form transparent SiO₂ (silicon dioxide) films over the entire inner surfaces of these substrates to prevent pollution within the touch panel and to improve the performance of close contact between the resistive films 13, 14, and then provide the resistive films 13, 14 on the SiO₂ films.

Furthermore, in the touch panel 10 according to this embodiment, a plurality of transparent projections 17, 18 having a height corresponding to the height of the projecting contacts 15 and the projecting spacers 16 are provided on the inner surface of the touch-side substrate 11 to correspond to the locations of the projecting contacts 15 and the projecting spacers 16. Moreover, the first resistive film 13 is formed over the projections 17, 18 so that parts covering the projections 17, 18 protrude from other parts. Thus, the projecting contacts 15 and the projecting spacers 16 are formed by the parts of the first resistive film 13 that cover the projections 17, 18. Hereinafter, the projections 17 for forming the projecting contacts 15 among the projections 17, 18 are referred to as contact projections, and the projections 18 for forming the projecting spacers 16 are referred to as spacer projections.

The contact projections 17 and the spacer projections 18 are arranged at predetermined intervals, and two or more contact projections 17 are arranged between adjacent two spacer projections 18.

In this embodiment, the spacer projections 18 are disposed at four corners of predetermined square regions. The contact projections 17 are arranged at predetermined intervals in at least the square regions.

The contact projections 17 and the spacer projections 18 are formed by spin-coating the inner surface of the touch-side substrate 11 with a transparent acrylic photosensitive resin to reach a thickness corresponding to the height of the contact projections 17 and the spacer projections 18 and developing and thus patterning the resin coating after exposed by use of an exposure mask having patterns corresponding to the planar shape and arrangement pitch of the contact projections 17 and the spacer projections 18. All of the contact projections 17 and the spacer projections 18 have the same height.

In addition, parts closer to the front side of the resin coating are exposed to a developer for a longer time in the development after the exposure. Thus, each of the contact projections 17 and the spacer projections 18 is formed into a shape which decreases in diameter from the base to the protruding end. In this embodiment, each of the projecting contacts 15 and the spacer projections 18 is formed into a tapered columnar shape. The shape of its section parallel to the surface of the touch-side substrate 11 is circular. The diameter of the base is 15 to 30 μm, and the height of the column is 2 to 5 μm.

Each of the first and second resistive films 13, 14 is made of a transparent conductive coating such as an ITO film which is formed into a thickness of 0.05 to 0.20 μm by a plasma CVD device. Of the resistive films 13, 14, the first resistive film 13 which is formed on the inner surface of the touch-side substrate 11 to cover the contact projections 17 and the spacer projections 18 provides its parts covering the contact projections 17 to form the projecting contacts 15. The projecting spacers 16 are formed by parts of the first resistive film 13 that cover the spacer projections 18.

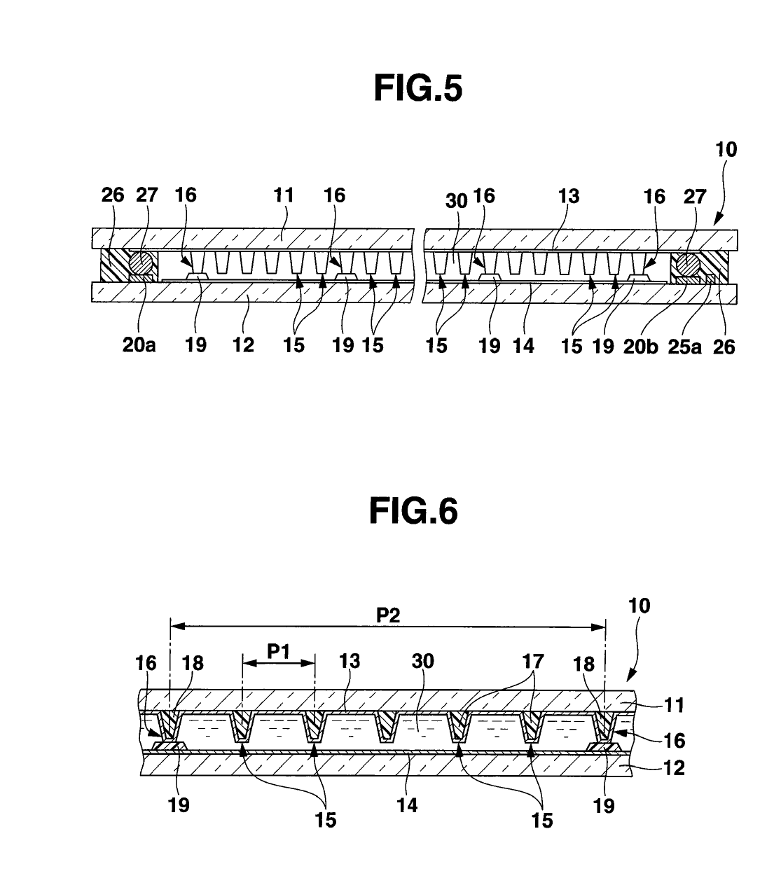

Although the height of the contact projections 17 and the spacer projections 18 is exaggerated in FIG. 5 to FIG. 8, the inclination angle (angle with the surface of the touch-side substrate 11) of the peripheral surfaces of the contact projections 17 and the spacer projections 18 is actually 40° to 50°. Thus, the first resistive film 13 is formed with a uniform thickness to entirely cover the contact projections 17 and the spacer projections 18, so that the projecting contacts 15 and the projecting spacers 16 can be formed.

The spacer receiving insulating layers 19 which are provided on the second resistive film 14 formed on the inner surface of the opposite substrate 12 to respectively correspond to the projecting spacers 16 are formed of, for example, transparent SiO₂ (silicon dioxide) films or acrylic transparent resin coatings having a thickness of 0.5 μm into a circular coating shape greater in area than the tips of the projecting spacers 16.

In addition, in order to form the spacer receiving insulating layers 19 made of the SiO₂ films, an SiO₂ film is formed on the second resistive film 14 by a sputter device, and the SiO₂ film is patterned by the formation of an etching mask based on a photolithographic method and by the subsequent etching.

Moreover, in order to form the spacer receiving insulating layers 19 made of the resin coatings, the second resistive film 14 is spin-coated with an acrylic photosensitive resin, and the resin coating is developed and thus patterned after exposed by use of an exposure mask having patterns corresponding to the planar shape and arrangement pitch of the spacer receiving insulating layers 19.

The pair of substrates 11, 12 are joined together by a frame-like seal member 26 which is disposed between the peripheral edges of the substrates 11, 12 and which circumferentially seals the gap between the pair of substrates 11, 12. The pair of substrates 11, 12 are joined together in the following condition: the first and second resistive films 13, 14 respectively formed on the inner surfaces of the substrates 11, 12 face each other; the tips of the projecting spacers 16 provided on the inner surface of the touch-side substrate 11 are in contact with the spacer receiving insulating layers 19 which are formed on the second resistive film 14 disposed on the inner surface of the opposite substrate 12; and the protruding ends of the projecting contacts 15 provided on the inner surface of the touch-side substrate 11 face the second resistive film 14 to leave a gap corresponding to the thickness of the spacer receiving insulating layers 19. An insulating liquid 30 is confined in a gap enclosed by the seal member 26 between the pair of substrates 11, 12.

In the touch panel 10 according to this embodiment, a rectangular region inside a seal portion formed by the frame-like seal member 26 serves as a touch area 31 for touch-input. Each of the first and second resistive films 13, 14 is formed into a rectangular shape greater than the touch area 31 and smaller than the outer shape of the seal portion.

Furthermore, the projecting spacers 16 are arranged at four corners of predetermined square regions, for example, quadrate regions to correspond to the locations of the spacer projections 18 in a region enclosed by the frame-like seal member 26, that is, in a region corresponding to the touch area 31. Two or more projecting contacts 15 are arranged between adjacent two projecting spacers 16, 16 to correspond to the locations of the contact projections 17 in the region corresponding to the touch area 31.

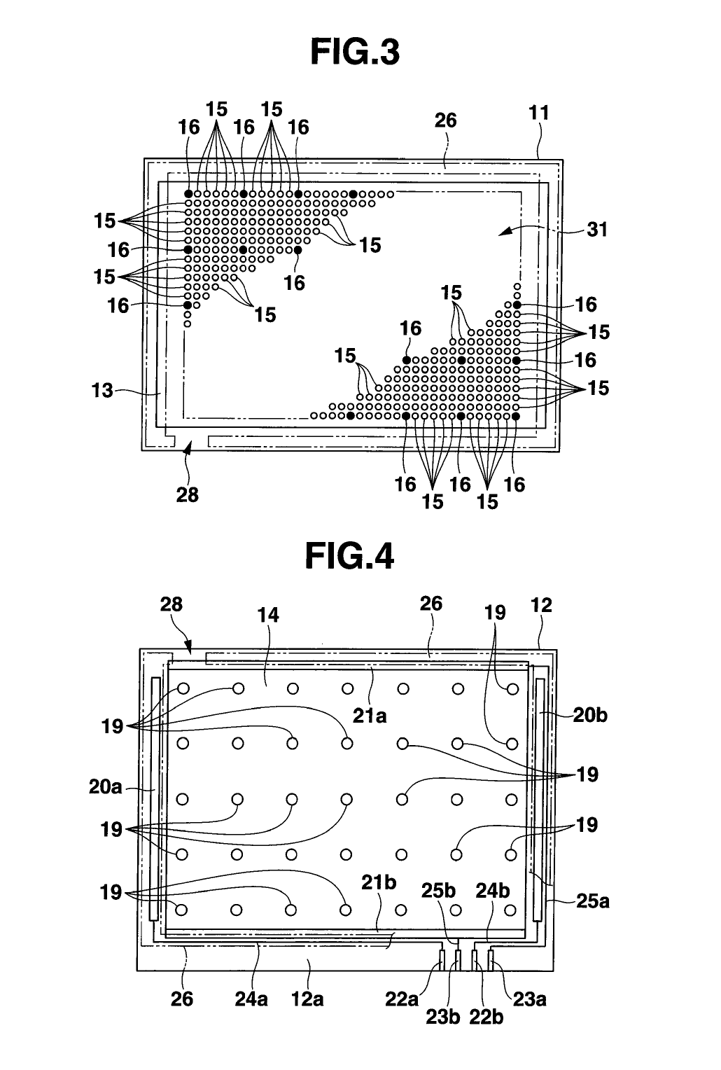

In this embodiment, the projecting contacts 15 are arranged with a predetermined pitch in two directions perpendicular to each other, for example, in the lateral and longitudinal directions of the touch area 31. Moreover, the projecting contacts 15 are arranged with a pattern in which a plurality of non-contact portions are provided by omitting one projecting contact 15 every predetermined number of projecting contacts 15 in each of contact point lines in the two directions. The projecting spacers 16 are arranged in the non-contact portions. In FIG. 3, the projecting spacers 16 are shown in black so that the projecting spacers 16 can be easily differentiated from the projecting contacts 15.

For example, the projecting contacts 15 are arranged with a pitch P1 of 0.05 mm, 0.1 mm or 0.2 mm in each of the two directions (lateral and longitudinal directions of the touch area 31). The projecting spacers 16 provided in the non-contact portions where the projecting contacts 15 are omitted are arranged with a pitch P2 of 2 mm or 4 mm in each of the two directions.

In addition, in FIG. 3 and FIG. 5 to FIG. 7, for the sake of convenience, one projecting spacer 16 is provided every five projecting contacts 15. On the other hand, when the pitch P1 of the projecting contacts 15 is 0.05 mm and the pitch P2 of the projecting spacers 16 is 2 mm, one projecting spacer 16 is provided every 38 projecting contacts 15. When P1 is 0.2 mm and P2 is 4 mm, one projecting spacer 16 is provided every 18 projecting contacts 15.

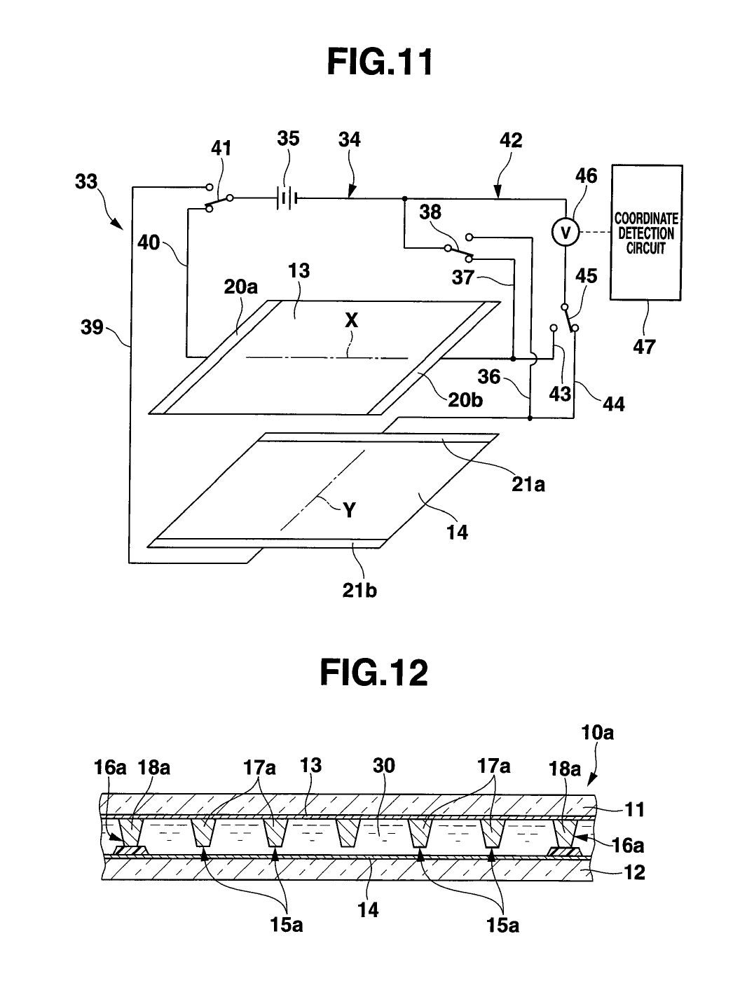

In the extension 12a of the opposite substrate 12, a plurality of, for example, four drive circuit connecting terminals 22a, 22b, 23a, 23b are provided to connect, to a touch panel drive circuit 33 shown in FIG. 11, both ends of one direction of the first resistive film 13 provided on the touch-side substrate 11, for example, the lateral direction of the touch area 31 (hereinafter referred to as an X-axis direction) and both ends of the direction of the second resistive film 14 provided on the opposite substrate 12 perpendicular to the above-mentioned one direction, that is, the longitudinal direction of the touch area 31 (hereinafter referred to as a Y-axis direction).

Furthermore, on the inner surface of the opposite substrate 12 where the drive circuit connecting terminals 22a, 22b, 23a, 23b are provided, there are provided a plurality of first electrodes 20a, 20b respectively facing edge portions at both ends of the first resistive film 13 provided on the touch-side substrate 11 in the X-axis direction, a plurality of second electrodes 21a, 21b respectively formed in edge portions at both ends of the second resistive film 14 provided on the opposite substrate 12 in the Y-axis direction, and a plurality of wiring lines 24a, 24b, 25a, 25b for connecting the first electrodes 20a, 20b and the second electrodes 21a, 21b to the four drive circuit connecting terminals 22a, 22b, 23a, 23b provided in the extension 12a.

The first resistive film 13 provided on the touch-side substrate 11 is formed into such a shape that its side portions at both ends of the X-axis direction are located in the seal portion formed by the frame-like seal member 26 and that its side portions at both ends of the Y-axis direction perpendicular to the X-axis direction are located inside the seal portion. The second resistive film 14 provided on the opposite substrate 12 is formed into a such shape that its side portions at both ends of the X-axis direction are located inside the seal portion and that its side portions at both ends of the Y-axis direction correspond to the vicinity of the seal portion or correspond to the seal portion.

The first electrodes 20a, 20b respectively facing the side portions at both ends of the first resistive film 13 in the X-axis direction are provided in the seal portion. The second electrodes 21a, 21b respectively formed in the side portions at both ends of the second resistive film 14 in the Y-axis direction are stacked on the second resistive film 14.

In addition, in the touch panel 10 according to this embodiment, the first electrodes 20a, 20b are respectively provided to face each other in the side portions at one end of the first resistive film 13 and the other in the X-axis direction, and the second electrodes 21a, 21b are respectively provided to face each other in the side portions at one end of the second resistive film 14 and the other in the Y-axis direction. The two first electrodes 20a, 20b are respectively formed into a continuous belt shape to face each other over the substantially entire lengths of the side portions at both ends of the first resistive film 13 in the X-axis direction. The two second electrodes 21a, 21b are formed into a continuous belt shape over the substantially entire lengths of the side portions at both ends of the second resistive film 14 in the Y-axis direction.

The two first electrodes 20a, 20b and the two second electrodes 21a, 21b are respectively connected to the four drive circuit connecting terminals 22a, 22b, 23a, 23b provided in the extension 12a by the plurality of (four in this embodiment) wiring lines 24a, 24b, 25a, 25b provided in the parts corresponding to the seal portion.

In addition, the first electrodes 20a, 20b and the second electrodes 21a, 21b, the drive circuit connecting terminals 22a, 22b, 23a, 23b and the wiring lines 24a, 24b, 25a, 25b are produced by forming, on the opposite substrate 12 or the second resistive film 14 in a stacked manner, a first layer made of molybdenum, a second layer made of an aluminum based alloy and a third layer made of molybdenum and then patterning the three-layer stack film.

Furthermore, the side portions at both ends of the first resistive film 13 in the X-axis direction are connected to the two first electrodes 20a, 20b by a conductive member in the seal portion. In this embodiment, the seal portion is composed of the frame-like seal member 26 and a plurality of spherical conductive particles 27. The conductive particles 27 are dispersed in the seal member 26 as conductive members for connecting the side portions at both ends of the first resistive film 13 in the X-axis direction to the two first electrodes 20a, 20b. The conductive particles 27 have a diameter corresponding to the gap between the pair of substrates 11, 12.

The seal member 26 is printed on the inner surface of one of the pair of substrates 11, 12 into a shape in which the side portion corresponding to the edge of the side opposite to the side where the extension 12a of the opposite substrate 12 is formed is partly eliminated to form a liquid filling hole 28. The pair of substrates 11, 12 are joined together in the following manner: The projecting spacers 16 provided on the inner surface of the touch-side substrate 11 are brought into contact with the spacer receiving insulating layers 19 provided on the second resistive film 14 on the inner surface of the opposite substrate 12. Thus, the gap between the substrates 11, 12 is regulated by the projecting spacers 16 and the spacer receiving insulating layers 19. In this condition, the seal member 26 is cured so that the substrates are joined together through the seal member 26.

When the pair of substrates 11, 12 are joined together through the seal member 26, the side portions at both ends of the first resistive film 13 provided on the touch-side substrate 11 in the X-axis direction are electrically connected to the two first electrodes 20a, 20b provided to face each other on the opposite substrate 12 in the side portions at both ends of the first resistive film 13 in the X-axis direction, by the conductive particles 27 held between the first resistive film 13 and the first electrodes 20a, 20b among the spherical conductive particles 27 dispersed in the seal member 26.

Furthermore, regarding the insulating liquid 30 confined in the gap enclosed by the seal member 26 between the pair of substrates 11, 12, the gap is filled with the insulating liquid 30 in the following manner: A vacuum is formed in a sealed chamber. Then, the liquid filling hole 28 is immersed in a bath filled with the insulating liquid 30. In this condition, the pressure in the chamber is brought back to atmospheric pressure. Thus, the insulating liquid 30 is injected into the gap between the pair of substrates 11, 12 through the liquid filling hole 28 due to the pressure difference between the inside of the chamber and the gap between the pair of substrates 11, 12. The liquid filling hole 28 is sealed with a sealing resin 29 after the filling with the insulating liquid 30.

The insulating liquid 30 is a transparent liquid, and the difference of refractive index between the insulating liquid 30 and the pair of substrates 11, 12 is 0.1 or less. That is, when the pair of substrates 11, 12 are glass plates, the refractive index of the substrates 11, 12 is about 1.5 and the refractive index of the insulating liquid 30 ranges from about 1.4 to 1.5. The refractive index of the insulating liquid 30 is preferably closer to the refractive index of the pair of substrates 11, 12, that is, about 1.5.

In this embodiment, as the insulating liquid 30, a material which is optically isotropic at room temperature (25° C.), for example, liquid crystal which shows an isotropic phase at a temperature of 5° C. or more (nematic liquid crystal having an N−1 point less than 5° C.) is confined in the gap between the pair of substrates 11, 12. Specifically, a known material having such characteristics has two or three cyclohexane or benzene rings, and an alkyl group at both ends thereof.

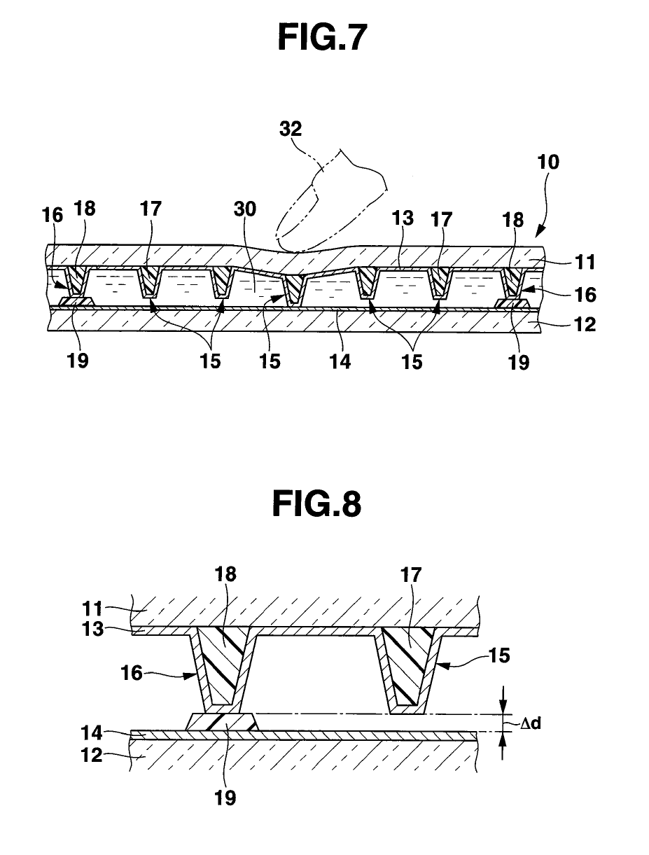

The touch panel 10 is touched for input by, for example, a fingertip 32 from the outer side of the touch-side substrate 11 as shown in FIG. 7. If the touch panel 10 is touched, the touch-side substrate 11 bends and deforms inward due to touching from its outer side. Among the projecting contacts 15 provided at a plurality of positions on the inner surface of the touch-side substrate 11, the projecting contact/s 15 at the touched portion (the bent and deformed portion of the touch-side substrate 11) contacts the second resistive film 14 on the inner surface of the opposite substrate 12. Thus, the first resistive film 13 and the second resistive film 14 are brought into local conduction at the touched portion.

In this touch panel 10, the projecting contacts 15 and the projecting spacers 16 are provided on the inner surface of the touch-side substrate 11 to protrude equally in height to the surface of the first resistive film 13 provided on the inner surface of the touch-side substrate 11. The spacer receiving insulating layers 19 formed into a predetermined thickness are provided on the second resistive film 14 which is provided on the inner surface of the opposite substrate 12, in such a manner as to respectively correspond to the projecting spacers 16. The projecting spacers 16 are respectively brought into contact with the spacer receiving insulating layers 19, so that the gap between the pair of substrates 11, 12 is set at a value higher than the height of the projecting contacts 15 by the projecting spacers 16 and the spacer receiving insulating layers 19. Therefore, a gap Δd (see FIG. 8) between the projecting contacts 15 and the second resistive film 14 is equal to the thickness of the spacer receiving insulating layers 19.

Thus, the bending and deforming amount of the touch-side substrate 11 necessary to bring the first resistive film 13 and the second resistive film 14 into local conduction at the touched portion can be sufficiently smaller than the gap between the pair of substrates 11, 12.

That is, for example, when the protruding height of the projecting contacts 15 and the projecting spacers 16 from the surface of the first resistive film 13 (the surface of the parts that do not serve for the projecting contacts 15 and the projecting spacers 16) is 3.5 μm and when the thickness of the spacer receiving insulating layers 19 is 0.5 μm, the gap between the pair of substrates 11, 12 is 4.0 μm, and the gap Δd between the projecting contacts 15 and the second resistive film 14 is 0.5 μm. The bending and deforming amount of the touch-side substrate 11 necessary to bring the first resistive film 13 and the second resistive film 14 into local conduction at the touched portion, that is, the gap Δd between the projecting contacts 15 and the second resistive film 14 (0.5 μm) is sufficiently smaller than the gap (4.0 μm) between the pair of substrates 11, 12.

Consequently, according to the touch panel 10, the refraction of light transmitted through the part of the touch-side substrate 11 bent and deformed by touching can be reduced. Therefore, in the touch-panel-equipped display apparatus shown in FIG. 1, an image displayed on the display panel 1 can be observed with little distortion even in the bent and deformed part of the touch-side substrate 11.

Moreover, according to the touch panel 10, the bending and deforming amount of the touch-side substrate 11 necessary to bring the first resistive film 13 and the second resistive film 14 into local conduction at the touched portion is small, so that touch-input can be performed with slight pressing force, and a sense of light touch can be obtained.

Furthermore, in the touch panel 10, the insulating liquid 30 is confined in the gap between the pair of substrates 11, 12. Thus, the reflection and refraction of the light passing through the touch panel 10 at the apparent interface between the pair of substrates 11, 12 and the layer of the insulating liquid 30, that is, at the interface where the resistive films 13, 14 intervene can be reduced. As a result, an image displayed on the display panel 1 can be observed with sufficient brightness.

That is, the resistive films 13, 14 made of, for example, ITO films are respectively provided on the inner surfaces of the pair of substrates 11, 12. Thus, the light passing through the touch panel 10 is reflected or refracted at the interface between the touch-side substrate 11 and the first resistive film 13, the interface between the opposite substrate 12 and the second resistive film 14, and the interface between the first and second resistive films 13, 14 and the pair of substrates 11, 12.

However, in the touch panel 10, the insulating liquid 30 is confined in the gap between the pair of substrates 11, 12. Therefore, the difference of refractive index is smaller between the first and second resistive films 13, 14 and the gap between the pair of substrates 11, 12 than when an air layer having a refractive index of 1 is formed in the gap. In addition, the refractive index of the resistive films 13, 14 made of, for example, the ITO films is about 1.8, and the refractive index of the insulating liquid 30 ranges from about 1.4 to 1.5, so that the difference of refractive index between the resistive films 13, 14 and the insulating liquid 30 ranges from about 0.4 to 0.3.

Thus, in the touch panel 10, the reflection and refraction of the light at the apparent interface between the pair of substrates 11, 12 and the layer of the insulating liquid 30 are lower than when an air layer having a refractive index of 1 is formed in the gap.

The insulating liquid 30 is preferably a liquid which differs in refractive index from the pair of substrates 11, 12 by 0.1 or less. If a liquid having such a refractive index is confined, the reflection of light at the apparent interface between the pair of substrates 11, 12 and the layer of the insulating liquid 30 can be more effectively reduced.

That is, the refractive index of the pair of substrates 11, 12 is about 1.5, the refractive index of the insulating liquid 30 ranges from about 1.4 to 1.5, and the refractive index of the resistive films 13, 14 is about 1.8. Thus, light which has entered the touch panel 10 in one direction, for example, from the outer side of the opposite substrate 12 is refracted at the interface between the opposite substrate 12 and the second resistive film 14 in a direction in which the angle with the normal direction of the touch panel 10 increases. Then, this light is refracted at the interface between the second resistive film 14 and the layer of the insulating liquid 30 in a direction in which the angle with the normal direction of the touch panel 10 decreases. Further, this light is refracted at the interface between the layer of the insulating liquid 30 and the first resistive film 13 in a direction in which the angle with the normal direction of the touch panel 10 increases. Finally, this light is refracted at the interface between the first resistive film 13 and the touch-side substrate 11 in a direction in which the angle with the normal direction of the touch panel 10 decreases.

However, each of the first and second resistive films 13, 14 is an extremely thin film having a thickness of 0.05 to 0.20 μm. Thus, the difference between the entrance position of the light at one of two interfaces between the second resistive film 14 and the fourth transparent substrate 12 as well as the layer of the insulating liquid 30 and the exit position of the light at the other interface is negligible. The difference between the entrance position of the light at one of two interfaces between the first resistive film 13 and the layer of the insulating liquid 30 as well as the touch-side substrate 11 and the exit position of the light at the other interface is also negligible.

Therefore, the difference between the positions at which the light enters or exits from the touch panel 10 substantially corresponds to the difference in refractive index between the pair of substrates 11, 12 and the insulating liquid 30. If the difference in refractive index is 0.1 or less, the refraction at the apparent interface between the pair of substrates 11, 12 and the layer of the insulating liquid 30 can be effectively reduced.

A material which is optically isotropic at room temperature, for example, liquid crystal which shows an isotropic phase at a temperature of 5° C. or more is desirably used for the insulating liquid 30. When this liquid crystal is confined, the reflection and refraction at room temperature at the apparent interface between the pair of substrates 11, 12 and the layer of the insulating liquid 30 can be reduced.

In addition, as the insulating liquid 30, an organic or inorganic insulating liquid substance of which boiling point is 100° C. or more can be used instead of the above-mentioned material which is optically isotropic at room temperature. Specifically, it is possible to use an organic liquid substance such as butanol, toluene, xylene, an isobutyl alcohol, an isopentyl alcohol, isobutyl acetate, butyl acetate, tetrachlorethylene, methyl isobutyl ketone, methyl butyl ketone, ethylene glycol monoether, ethylene glycol monoether acetate, ethylene glycol monobutyl ether, ethylene glycol monomethyl ether or turpentine oil. Alternatively, it is possible to use an inorganic liquid substance such as silicon oil.

Furthermore, in the touch panel 10, the contact projections 17 and the spacer projections 18 made of a transparent photosensitive resin are provided on the inner surface of the touch-side substrate 11. The first resistive film 13 made of a transparent conductive coating is provided over the projections 17, 18. As a result, the projecting contacts 15 are formed by parts of the first resistive film 13 that cover the contact projections 17. The projecting spacers 16 are formed by parts of the first resistive film 13 that cover the spacer projections 18. Further, the spacer receiving insulating layers 19 made of transparent SiO₂ films or transparent resin films are formed on the second resistive film 14 which is made of a transparent conductive coating and which is provided on the inner surface of the opposite substrate 12. Therefore, for example, in contrast with the case where the first resistive film 13 is formed on the inner surface of the touch-side substrate 11 and a plurality of contact points are formed thereon by a conductive metal, transmitted light is not blocked by the contact points. Thus, an image displayed on the display panel 1 can be observed without any black points produced in parts corresponding to the projecting contacts 15 and the projecting spacers 16.

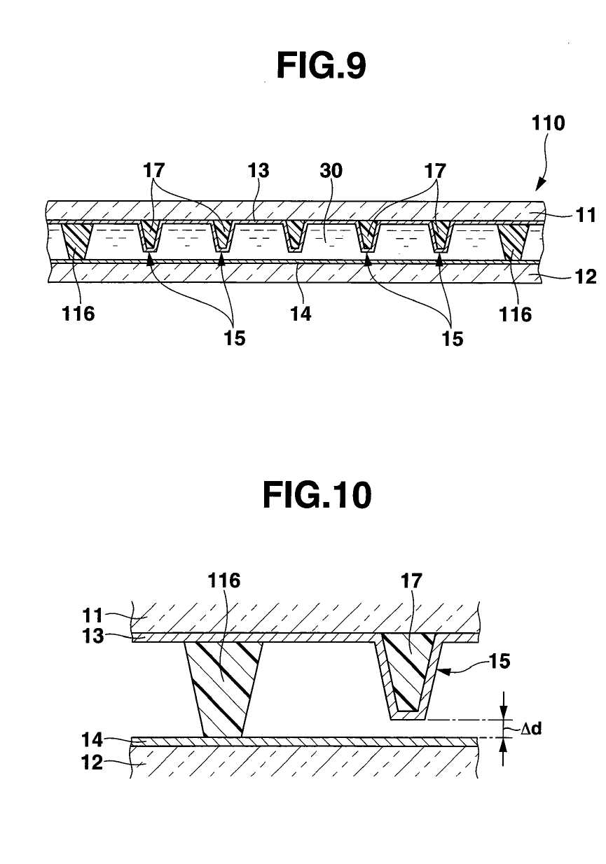

Moreover, in the touch panel 10, the projecting contacts 15 and the projecting spacers 16 are formed of the same material at the same height. Thus, variation of the sense of touch among products (among touch panels) as in a touch panel 110 of a comparative example shown in FIG. 9 and FIG. 10 can be reduced.

In the touch panel 110 of the comparative example shown in FIG. 9, a plurality of contact projections 17 are provided on the inner surface of a touch-side substrate 11, and a first resistive film 13 is provided over the contact projections 17. Thus, a plurality of projecting contacts 15 are formed by the contact projections 17 and by parts of the first resistive film 13 that cover the contact projections 17. Insulating columnar spacers 116 are provided on the first resistive film 13 to protrude higher than the projecting contacts 15. In the touch panel 110 of this comparative example, the columnar spacers 116 are brought into contact with a second resistive film 14 provided on the inner surface of an opposite substrate 12 to regulate the gap between the pair of substrates 11, 12 and to set a gap Δd between the projecting contacts 15 and the second resistive film 14 at a value corresponding to the difference of height between the projecting contacts 15 and the columnar spacers 116. In addition, the configuration of the touch panel 110 of this comparative example is the same in other respects as that of the touch panel 10 in the embodiment described above.

In the touch panel 110 of the comparative example, the projecting contacts 15 and the columnar spacers 116 are formed in the following processes: The contact projections 17 are formed on the inner surface of the touch-side substrate 11 by spin-coating with a photosensitive resin and by the exposure and development of the resin coating. The first resistive film 13 is formed over the contact projections 17 to form the projecting contacts 15. Then, the columnar spacers 116 are formed on the first resistive film 13 by spin-coating with a photosensitive resin and by the exposure and development of the resin coating.

In the touch panel 110 of the comparative example, the projecting contacts 15 and the columnar spacers 116 are formed in the separate processes. Therefore, there is a considerable margin of error among products in the gap Δd between the projecting contacts 15 and the second resistive film 14.

That is, the contact projections 17 and the columnar spacers 116 are formed in the above-mentioned processes. Thus, the height of the columnar spacers 116 as well as the height of the contact projections 17 is constant in one product. However, it is difficult to ensure a constantly equal coating thickness in each process of coating with the photosensitive resin. As a result, there is a margin of error in the height of the projecting contacts 15 and the height of the columnar spacers 116 among manufactured products. The error in the height of the projecting contacts 15 and the error in the height of the columnar spacers 116 lead to the variation of the gap Δd between the projecting contacts 15 and the second resistive film 14 among products.

For example, suppose that the error in a design value for the height of the projecting contacts 15 actually formed is 5% and that the error in a design value for the height of the columnar spacers 116 actually formed is 5%. Then, the height of the projecting contacts 15 actually formed when the design value for the height of the projecting contacts 15 is 3.5 μm is 3.5 μm±5%=3.325 to 3.675 μm. The height of the columnar spacers 116 actually formed when the design value for the height of the columnar spacers 116 is 4.0 μm is 4.0 μm±5%=3.8 to 4.2 μm.

Thus, in the touch panel 110 of the comparative example, the error in the height of the projecting contacts 15 and the error in the height of the columnar spacers 116 cause a margin of error of ±0.375 μm in the design value for the gap Δd between the projecting contacts 15 and the second resistive film 14 (Δd=4.0 μm±3.5 μm=0.5 μm).

For example, in a product in which the projecting contacts 15 are formed at a height of 3.325 μm and the columnar spacers 116 are formed at a height of 4.2 μm, Δd=4.2 μm−3.325 μm=0.875 μm, so that the gap Δd is 0.375 μm higher than the design value (Δd=0.5 μm). Thus, in this product, the touch-side substrate 11 has to be greatly bent and deformed by strong touch force, which provides a sense of heavy touch.

Moreover, in a product in which the projecting contacts 15 are formed at a height of 3.675 μm and the columnar spacers 116 are formed at a height of 3.8 μm, Δd=3.8 μm−3.675 μm=0.125 μm, so that the gap Δd is 0.375 μm lower than the design value (Δd=0.5 μm). Thus, this product provides a sense of extremely light touch, and only a light touch on the touch-side substrate 11 may cause the projecting contacts 15 to contact the second resistive film 14, resulting in erroneous input.

In contrast with the touch panel 110 of the comparative example, the projecting contacts 15 and the projecting spacers 16 are formed of the same material at the same height in the touch panel 10 according to the embodiment described above. Thus, even if there are errors in the height of the projecting contacts 15 and the height of the projecting spacers 16 among products, there is no difference of height between the projecting contacts 15 and the projecting spacers 16 in one product.

Therefore, in the touch panel 10 according to this embodiment, the margin of error of the gap Δd between the projecting contacts 15 and the second resistive film 14 among products is within the range of error in the thickness of the spacer receiving insulating layers 19.

For example, in this touch panel 10, if the error in a design value for the thickness of the spacer receiving insulating layers 19 actually formed is 5%, the thickness of the spacer receiving insulating layers 19 actually formed when the design value for the thickness of the spacer receiving insulating layers 19 is 0.5 μm is 0.5 μm±5%=0.475 to 0.525 μm.

That is, in this touch panel 10, when the design value for the gap Δd between the projecting contacts 15 and the second resistive film 14 is 0.5 μm, the margin of error in the design value for the gap Δd among products is ±0.025 and extremely small. As a result, the variation of the sense of touch among products can be reduced.

In the touch panel 10 according to this embodiment, the spacer receiving insulating layers 19 may be formed of either SiO₂ films or resin films as described above. The SiO₂ film can be formed with a precise thickness by the sputter device.

Therefore, the spacer receiving insulating layers 19 are preferably formed of the SiO₂ films. In this case, there is hardly any error in the thickness of the spacer receiving insulating layers 19, that is, there is hardly any error in the gap Δd in each product. As a result, the variation in the sense of touch among products can be more effectively reduced.

In the touch panel 10, the touch-side substrate 11 bends and deforms inward due to the touching from its outer side, and the projecting contact 15 at the touched portion among the projecting contacts 15 contacts the second resistive film 14 on the inner surface of the opposite substrate 12, so that the first resistive film 13 and the second resistive film 14 are brought into conduction at the touched portion. Thus, the touch panel drive circuit 33 shown in FIG. 11 alternately applies a voltage at a given value across both ends of the first resistive film 13 in the X-axis direction and across both ends of the second resistive film 14 in the Y-axis direction. Then, the voltage value at one end of the second resistive film 14 when the voltage is applied to the first resistive film 13 and the voltage value at one end of the first resistive film 13 when the voltage is applied to the second resistive film 14 are measured. On the basis of these voltage values, coordinates of the touched point in the X-axis direction and the Y-axis direction can be detected.

The touch panel drive circuit 33 includes a voltage applying circuit 34, a voltage measuring system 42 and coordinate detection circuit 47. The voltage applying circuit 34 alternately applies a voltage at a given value across both ends of the first resistive film 13 in the X-axis direction and across both ends of the second resistive film 14 in the Y-axis direction. The voltage measuring system 42 measures a voltage generated across a predetermined point on the voltage applying circuit 34 and one end of the first resistive film 13 in the X-axis direction or one end of the second resistive film 14 in the Y-axis direction when the first resistive film 13 and the second resistive film 14 are brought into conduction through the projecting contact/s 15 in the bent and deformed part of the touch-side substrate 11. The coordinate detection circuit 47 detects coordinates of the touched point on the basis of the measurement value obtained by the voltage measuring system 42.

The voltage applying circuit 34 includes a constant voltage power source 35, a first connection changing switch 38 and a second connection changing switch 41. The first connection changing switch 38 selectively supplies a voltage of one pole (negative pole in FIG. 11) of the constant voltage power source 35 to one end of the first resistive film 13 in the X-axis direction and one end of the second resistive film 14 in the Y-axis direction through first resistive film connecting wiring lines 36, 37 respectively connected to one end of the first resistive film 13 in the X-axis direction and one end of the second resistive film 14 in the Y-axis direction. The second connection changing switch 41 selectively supplies a voltage of the other pole (positive pole in FIG. 11) of the constant voltage power source 35 to the other end of the first resistive film 13 in the X-axis direction and the other end of the second resistive film 14 in the Y-axis direction through second resistive film connecting wiring lines 39, 40 respectively connected to the other end of the first resistive film 13 in the X-axis direction and the other end of the second resistive film 14 in the Y-axis direction. Although the constant voltage power source 35 shown in FIG. 11 is a direct-current power source, the constant voltage power source 35 may be a power source for supplying an alternating voltage.

The voltage measuring system 42 includes a third connection changing switch 45 and a voltage detector 46. The third connection changing switch 45 selectively supplies, to the voltage detector 46, the voltage at one end of the first resistive film 13 in the X-axis direction and the voltage at one end of the second resistive film 14 in the Y-axis direction through third resistive film connecting wiring lines 43, 44 respectively connected to one end of the first resistive film 13 in the X-axis direction and one end of the second resistive film 14 in the Y-axis direction. The voltage detector 46 intervenes between one pole (negative pole in FIG. 11) of the constant voltage power source 35 and the third connection changing switch 45.

In accordance with unshown controller, the first and second connection changing switches 38, 41 are changed, with a predetermined period, for example, with a period of 0.1 seconds, between the side (state in FIG. 11) for connecting both ends of the first resistive film 13 in the X-axis direction to the constant voltage power source 35 and the side for connecting both ends of the second resistive film 14 in the Y-axis direction to the constant voltage power source 35. Thereby, the voltage applying circuit 34 alternately applies the voltage of the constant voltage power source 35 at a given value across both ends of the first resistive film 13 in the X-axis direction and across both ends of the second resistive film 14 in the Y-axis direction.

The coordinate detection circuit 47 is controlled by the unshown controller. The coordinate detection circuit 47 detects coordinates of the touched point in the X-axis direction (hereinafter referred to as X coordinates) on the basis of the measurement value obtained by the voltage detector 46 when the voltage is applied across both ends of the first resistive film 13 in the X-axis direction. The coordinate detection circuit 47 also detects coordinates of the touched point in the Y-axis direction (hereinafter referred to as Y coordinates) on the basis of the measurement value obtained by the voltage detector 46 when the voltage is applied across both ends of the second resistive film 14 in the Y-axis direction.

The X, Y coordinates of the touched point are detected on the basis of the measurement value obtained by the voltage detector 46 in accordance with the following computation.

A measurement voltage value V(x) obtained by the voltage detector 46 when a voltage V₀ is applied across both ends of the first resistive film 13 in the X-axis direction can be represented by,

as rₓ<<R,

V(x)=V₀(1−x)

wherein V₀ is the voltage value of the constant voltage power source 35, 0 is the value of the X coordinates at one end of the first resistive film 13 in the X-axis direction, 1 is the value of the X coordinates at the other end of the first resistive film 13 in the X-axis direction, x is the X coordinates of the touched point, rₓ is the value of resistance across both ends of the first resistive film 13 in the X-axis direction, and R is the value of the internal resistance of the voltage detector 46.

Moreover, a measurement voltage value V(y) obtained by the voltage detector 46 when the voltage V₀ is applied across both ends of the second resistive film 14 in the Y-axis direction can be represented by,

as r_{y}<<R,

V(y)=V₀(1−y)

wherein 0 is the value of the Y coordinates at one end of the second resistive film 14 in the Y-axis direction, 1 is the value of the Y coordinates at the other end of the second resistive film 14 in the Y-axis direction, y is the Y coordinates of the touched point, and r_{y} is the value of resistance across both ends of the second resistive film 14 in the Y-axis direction.

Therefore, X coordinates x and Y coordinates y of the touched point can be found by

x=1−V(x)/V₀

y=1−V(y)/V₀

Furthermore, in the touch panel 10, the two first electrodes 20a, 20b in a continuous belt shape are provided to face each other over the substantially entire lengths of the side portions at both ends of the first resistive film 13 in the X-axis direction. The two second electrodes 21a, 21b in a continuous belt shape are provided over the substantially entire lengths of the side portions at both ends of the second resistive film 14 in the Y-axis direction. The first electrodes 20a, 20b and the second electrodes 21a, 21b are respectively connected to the drive circuit connecting terminals 22a, 22b, 23a, 23b provided in the extension 12a of the opposite substrate 12 by the wiring lines 24a, 24b, 25a, 25b. As a result, the voltage alternately applied by the touch panel drive circuit 33 across both ends of the first resistive film 13 in the X-axis direction and across both ends of the second resistive film 14 in the Y-axis direction equally acts on the substantially entire first resistive film 13 and second resistive film 14, so that the X coordinates x and Y coordinates y of the touched point can be accurately detected.

Consequently, the touch-panel-equipped display apparatus shown in FIG. 1 provides keyboard-like touch input, wherein a plurality of key patterns are displayed on the display panel 1, and parts corresponding to the key patterns in the touch panel 10 are selectively touched. In addition to this keyboard-like touch input, the touch-panel-equipped display apparatus provides the following functions. For example, an image is displayed on the display panel 1, and a given point on the touch panel 10 is touched, whereby an enlarged image centered on the touched point is displayed on the display panel 1. Moreover, the touched point can be moved in a given direction on the touch panel 10 to scroll the image displayed on the display panel 1.

In addition, the first electrodes 20a, 20b and the second electrodes 21a, 21b are respectively formed into the continuous belt shape in the embodiment described above. However, the first electrodes 20a, 20b and the second electrodes 21a, 21b may be intermittently provided with a predetermined pitch over the substantially entire lengths of the side portions at both ends of the first resistive film 13 in the X-axis direction and over the substantially entire lengths of the side portions at both ends of the second resistive film 14 in the Y-axis direction, respectively. In this case as well, the voltage alternately applied across both ends of the first resistive film 13 in the X-axis direction and across both ends of the second resistive film 14 in the Y-axis direction equally acts on the substantially entire first resistive film 13 and second resistive film 14, so that the X coordinates x and Y coordinates y of the touched point can be accurately detected.

When the first electrodes 20a, 20b and the second electrodes 21a, 21b are thus intermittently provided over the substantially entire lengths of the side portions at both ends of the first resistive film 13 in the X-axis direction and over the substantially entire lengths of the side portions at both ends of the second resistive film 14 in the Y-axis direction, respectively, the first electrodes facing each other are connected to the common side portion at one end of the first resistive film 13 in the X-axis direction, the first electrodes facing each other are connected to the common side portion at the other end of the first resistive film 13 in the X-axis direction, the second electrodes facing each other are connected to the common side portion at one end of the second resistive film 14 in the Y-axis direction, and the second electrodes facing each other are connected to the common side portion at the other end of the second resistive film 14 in the Y-axis direction. Then, these electrodes can be connected to the drive circuit connecting terminals 22a, 22b, 23a, 23b provided in the extension 12a of the opposite substrate 12 through the wiring lines 24a, 24b, 25a, 25b.

Furthermore, in the embodiment described above, an edge at the other end of the first resistive film 13 in the X-axis direction is electrically connected to the first electrodes 20a, 20b provided to face the ends of the first resistive film 13 by the spherical conductive particles 27 dispersed in the seal member 26. However, the side portion at the other end of the first resistive film 13 in the X-axis direction may be electrically connected to the first electrodes 20a, 20b through a columnar conductive member which is provided on the side portion or the first electrodes 20a, 20b to correspond to the seal portion formed by the seal member 26.

### Embodiment 2

Next, a touch panel according to a second embodiment of this invention shown in FIG. 12 is described. It is to be noted that parts in this embodiment equivalent to the parts in the first embodiment described above are provided with the same reference numbers and the same parts are not described.

In a touch panel 10a according to this embodiment, both a first resistive film 13 on the inner surface of a touch-side substrate 11 and a second resistive film 14 on the inner surface of an opposite substrate 12 are formed into planar films having planar surfaces. On the first resistive film 13 formed by the planar film, there are provided a plurality of projecting contacts 15a formed by conductive projections 17a to protrude at a predetermined height, and a plurality of projecting spacers 16a made of the same material as the conductive projections 17a and formed by conductive projections 18a to protrude at the same height as the conductive projections 17a. The configuration of the touch panel 10a is the same in other respects as that of the touch panel 10 in the first embodiment.

In this touch panel 10a, the conductive projections 17a, 18a are formed by spin-coating the first resistive film 13 with a transparent resin to which powder of a transparent conductive material such as ITO is added or with a transparent conductive material such as a conductive polymer (e.g., polyacetylene, polyparaphenylene, polyaniline, polythiophene or polyparaphenylenevinylene) to reach a thickness corresponding to the height of the conductive projections 17a, 18a, and then patterning this film.

The touch panel 10a according to this embodiment has such a configuration. Thus, as in the touch panel 10 according to the first embodiment, the bending and deforming amount of the touch-side substrate 11 is reduced to reduce the refraction of light transmitted through the bent and deformed part of the touch-side substrate 11. Moreover, the variation of the sense of touch among products can be reduced.

### Embodiment 3

The touch panel 10, 10a in the first and second embodiments is not exclusively used for the touch-panel-equipped display apparatus, and can be used for, for example, a touch-input type keyboard which does not require transparency. In this case, the pair of substrates 11, 12 may be opaque substrates, and the first and second resistive films 13, 14 may be formed by opaque metal films.

Furthermore, in the case of the touch panel which does not require transparency, the contact projections 17 and the spacer projections 18 in the first embodiment may be formed of an opaque material, and the contact point conductive projections 17a and the spacer conductive projections 18a in the second embodiment may be formed of, for example, a resin to which carbon powder is added, and moreover, the spacer receiving insulating layers 19 in the first and second embodiments may be formed of an opaque insulating material.

In the touch panel 10, 10a according to the embodiments described above, the drive circuit connecting terminals 22a, 22b, 23a, 23b are provided in the opposite substrate 12. However, an extension may be formed in the touch-side substrate 11, and the drive circuit connecting terminals may be provided in the extension.

In this case, the second resistive film 14 provided on the opposite substrate 12 may be formed into such a shape that its side portions at both ends of its one direction, for example, the X-axis direction are located in the seal portion formed by the frame-like seal member 26 and that its side portions at both ends of a direction perpendicular to the above-mentioned one direction, for example, the Y-axis direction are located inside the seal portion. The first resistive film 13 provided on the touch-side substrate 11 may be formed into such a shape that its side portions at both ends of the X-axis direction are located inside the seal portion and that its side portions at both ends of the Y-axis direction correspond to the vicinity of the seal portion or correspond to the seal portion. On the inner surface of the touch-side substrate 11, there may be provided a plurality of first electrodes respectively facing edges at both ends of the second resistive film 14 provided on the opposite substrate 12 in the X-axis direction, a plurality of second electrodes respectively formed on edges at both ends of the first resistive film 13 provided on the touch-side substrate 11 in the Y-axis direction, and a plurality of wiring lines for connecting the first electrodes and the second electrodes to the drive circuit connecting terminals.

Furthermore, in the touch panel 10, 10a according to the embodiments described above, the touch-side substrate 11 and the resistive film 13 formed on the touch-side substrate 11 respectively serve as the first substrate and the first resistive film, and the opposite substrate 12 and the resistive film 14 formed on the opposite substrate 12 respectively serve as the second substrate and the second resistive film. On the contrary, the opposite substrate 12 and the resistive film 14 formed on the opposite substrate 12 may respectively serve as the first substrate and the first resistive film, and the touch-side substrate 11 and the resistive film 13 formed on the touch-side substrate 11 may respectively serve as the second substrate and the second resistive film. Further, the projecting contacts 15, 15a and the projecting spacers 16, 16a may be provided on the resistive film 14 formed on the inner surface of the opposite substrate 12. The spacer receiving insulating layers 19 may be provided on the resistive film 13 formed on the inner surface of the touch-side substrate 11.

Moreover, the touch panel according to this invention is not limited to the configurations in the first and second embodiments. The touch panel may comprise the projecting contacts 15, 15a and the projecting spacers 16, 16a that are provided at a plurality of positions of the first resistive film 13 to protrude at a predetermined first height, and the spacer receiving insulating layers 19 that are provided on the second substrate 12 in a state protruding at a predetermined second height to correspond to the projecting spacers 16, 16. The second resistive film 14 is formed closer to the second substrate 12 than the insulating layers 19 so that at least its regions corresponding to the projecting contacts 15, 15a are exposed from the insulating layers 19. The tips of the projecting spacers 16, 16a are in contact with the insulating layers 19.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A touch panel comprising:
a first substrate;
a second substrate disposed to face the first substrate;
a resistive film formed on the second substrate;
spacer receivers formed of an insulating material on the resistive film, the spacer receivers having a predetermined area and a predetermined thickness;
projecting spacers formed on the first substrate, the projecting spacers protruding at a predetermined height, the tips of the projecting spacers being in contact with the spacer receivers; and
projecting contacts formed on the first substrate, the projecting contacts protruding equally in height to the projecting spacers, the tips of the projecting contacts being out of contact with the spacer receivers.

2. The touch panel according to claim 1, wherein the projecting spacers are arranged at predetermined intervals, and two or more projecting contacts are arranged at predetermined intervals between adjacent two projecting spacers.

3. The touch panel according to claim 1, wherein the projecting spacers are each disposed four corners of predetermined square regions, and the projecting contacts are arranged at predetermined intervals in the square regions.

4. The touch panel according to claim 1, wherein each of the projecting spacers and the projecting contacts includes a resin portion formed into a projection shape on the first substrate, and a resistive film formed on the first substrate so as to cover the resin portion.

5. The touch panel according to claim 4, further comprising a detection circuit which detects a coordinate position at which the resistive film formed on the first substrate and the resistive film formed on the second substrate are brought into electric conduction.

6. The touch panel according to claim 1, wherein each of the projecting spacers and the projecting contacts includes a resistive film formed on the first substrate, and a projection made of a conductive material and formed on the resistive film.

7. The touch panel according to claim 6, further comprising a detection circuit which detects a coordinate position at which the resistive film formed on the first substrate and the resistive film formed on the second substrate are brought into electric conduction through the projections.

8. The touch panel according to claim 1, wherein the spacer receivers is formed of SiO₂.

9. The touch panel according to claim 1, wherein the spacer receivers is formed of a resin.

10. The touch panel according to claim 1, wherein the first substrate and the second substrate are joined together by a frame-like seal member, and an insulating material which is in a liquid state at room temperature is confined in a region enclosed by the seal member.

11. The touch panel according to claim 10, wherein the boiling point of the liquid is 100° C. or more.

12. The touch panel according to claim 1, wherein the first substrate and the second substrate are joined together by a frame-like seal member, and an insulating material is confined in a region enclosed by the seal member, the insulating material showing an isotropic phase at room temperature, the transition point of the insulating material between the isotropic phase and a liquid crystal phase being less than 5° C.

13. The touch panel according to claim 1, wherein the first substrate and the second substrate are joined together by a frame-like seal member, and the projecting spacers and the projecting contacts are formed in a region enclosed by the seal member.

14. The touch panel according to claim 1, wherein the resistive film is made of ITO.

15. A touch panel comprising:
a first substrate;
a second substrate disposed to face the first substrate;
projecting spacers formed on the first substrate, the projecting spacers protruding at a predetermined height;
projecting contacts formed on the first substrate, the projecting contacts protruding equally in height to the projecting spacers and being off the location of the projecting spacers;
a resistive film formed on the second substrate; and
spacer receivers formed of an insulating material with a predetermined thickness on the resistive film, the spacer receivers being only in contact with the projecting spacers between the projecting spacers and the projecting contacts.

16. The touch panel according to claim 15, wherein each of the projecting spacers and the projecting contacts includes a resin portion formed into a projection shape on the first substrate, and a resistive film formed on the first substrate so as to cover the resin portion.

17. The touch panel according to claim 15, wherein each of the projecting spacers and the projecting contacts includes a resistive film formed on the first substrate, and a projection made of a conductive material and formed on the resistive film.

18. A touch panel comprising:
a first substrate;
a second substrate disposed to face the first substrate;
projecting spacers formed on the first substrate, the projecting spacers protruding at a predetermined height;
projecting contacts formed on the first substrate, the projecting contacts protruding equally in height to the projecting spacers and being off the location of the projecting spacers;
a resistive film formed on the second substrate; and
insulating layers formed on the resistive film so that regions corresponding to the projecting contacts are exposed from the insulating layers and the tips of the projecting spacers are in contact with the insulating layers.

19. The touch panel according to claim 18, wherein each of the projecting spacers and the projecting contacts includes a resin portion formed into a projection shape on the first substrate, and a resistive film formed on the first substrate so as to cover the resin portion.

20. The touch panel according to claim 18, wherein each of the projecting spacers and the projecting contacts includes a resistive film formed on the first substrate, and a projection made of a conductive material and formed on the resistive film.
